(19) United States
(12) Patent Application Publication
(10) Pub. No.: US 2017/0046145 A1
(43) Pub. Date: Feb. 16, 2017

(54) SYSTEMS AND METHODS FOR DYNAMICALLY INSTALLING A PROGRAM'S DEPENDENT MODULES BEFORE PROGRAM EXECUTION

(71) Applicants: Jason C. Schultz, Roseville, MN (US); John A. Peters, Roseville, MN (US); Robert L. Bergerson, Roseville, MN (US); James R. Heit, Roseville, MN (US)

(72) Inventors: Jason C. Schultz, Roseville, MN (US); John A. Peters, Roseville, MN (US); Robert L. Bergerson, Roseville, MN (US); James R. Heit, Roseville, MN (US)

(73) Assignee: UNISYS CORPORATION, Blue Bell, PA (US)

(21) Appl. No.: 14/825,621

(22) Filed: Aug. 13, 2015

(51) Int. Cl. G06F 9/445

(52) U.S. Cl. CPC G06F 8/61; G06F 9/445; G06F 9/44521

(57) ABSTRACT

Systems and methods for dynamically installing a program's dependent software modules before program execution are disclosed. Embodiments may include extracting, from a file that includes at least a program to be executed on the computing system and one or more software modules on which the program depends for execution, the one or more software modules on which the program depends for execution. Embodiments may also include installing the one or more software modules on the computing system after the one or more software modules have been extracted. Embodiments may further include loading and executing the program after the one or more software modules have been installed on the computing system.

### FIELD OF THE DISCLOSURE

The instant disclosure relates to computing systems. More specifically, this disclosure relates to dynamic installation of a program's dependent software modules in a computing system before executing the program on the computing system.

### BACKGROUND

Computer programs are often built by a computing system using software modules available on the computing system. After being built, the computer program may be delivered to another computing system so that the computer program can be installed and used on the other computing system. In many instances, in order to properly load and execute the computer program, the other computing system must have access to and be able to use the software modules that were used to build the computer program. Therefore, if the other computing system does not have the software modules upon which the computer program depends for proper execution, the computer program may not property load or execute or even be useable on the other computing system.

Conventional systems have attempted to address the problem of missing software modules required for proper loading and executing of computer programs in many different ways. For example, most systems attempt to address the problem by requesting, retrieving, and installing the required software modules after the computer program has failed to load and execute. However, this solution delays, often times significantly, the installation and use of the computer program because of the time consumed in requesting, retrieving, and installing the missing software modules and then reloading and installing the computer program.

Another solution common in conventional systems is separate pre-installation of software modules commonly required for execution of common computer programs. Although such a system reduces the delay in releasing the computer program on the computing system because the required software modules may already be installed on the computing system, the solution has the drawback of installing software modules that may not be necessary for proper execution of the computer program. That is, more software modules than are necessary for execution of the computer program may end up being installed on the computing system. Therefore, such a solution often leads to wasted expenditures.

### SUMMARY

Installation of computer programs on computing systems may be improved by packaging, during the build of the computer program, the computer program together with the software modules the computer program requires for execution so that a computing system receiving the packaged computer program and associated software modules may extract and install the software modules before executing the computer program to ensure that the computer program properly loads and executes. In particular, a method for dynamically installing a program's dependent software modules before program execution may include extracting, by a computing system, from a file that includes at least a program to be executed on the computing system and one or more software modules on which the program depends for execution, the one or more software modules on which the program depends for execution. The method may also include installing, by the computing system, the one or more software modules on the computing system after the one or more software modules have been extracted. The method may further include loading and executing the program, by the computing system, after the one or more software modules have been installed on the computing system.

According to another embodiment, a computer program product may include a non-transitory computer-readable medium comprising instructions which, when executed by a processor of a computing system, cause the processor to perform the step of extracting, from a file that includes at least a program to be executed on the computing system and one or more software modules on which the program depends for execution, the one or more software modules on which the program depends for execution. The medium may also include instructions which, when executed by a processor of a computing system, cause the processor to perform the step of installing the one or more software modules on the computing system after the one or more software modules have been extracted. The medium may further include instructions which, when executed by a processor of a computing system, cause the processor to perform the step of loading and executing the program after the one or more software modules have been installed on the computing system.

According to yet another embodiment, an apparatus may include a memory and a processor coupled to the memory. The processor may be configured to execute the step of extracting, from a file that includes at least a program to be executed on the computing system and one or more software modules on which the program depends for execution, the one or more software modules on which the program depends for execution. The processor may also be configured to execute the step of installing the one or more software modules on the computing system after the one or more software modules have been extracted. The processor may be further configured to execute the step of loading and executing the program after the one or more software modules have been installed on the computing system.

The foregoing has outlined rather broadly the features and technical advantages of the present invention in order that the detailed description of the invention that follows may be better understood. Additional features and advantages of the invention will be described hereinafter that form the subject of the claims of the invention, it should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a flow chart illustrating a method for dynamically installing a program's dependent software modules before program execution according to one embodiment of the disclosure.

FIGS. 2A-2B are diagrams illustrating the building of a packaged file that includes a computer program and the software modules on which the computer program relies for loading and execution according to one embodiment of the disclosure.

FIG. 3 is a block diagram illustrating a computer network according to one embodiment of the disclosure.

FIG. 4 is a block diagram illustrating a computer system according to one embodiment of the disclosure.

### DETAILED DESCRIPTION

A computer program can be packaged with the dependent software modules used to build the computer program to ensure that all resources necessary for proper loading and execution of the computer program are available on a computing system on which the computer program is to be installed regardless of the resources available on the computing system. Accordingly, a computing system on which a computer program is to be installed may, with reception of a single software package, have all resources necessary to execute the computer program on the computing system. As a result, the delay and/or wasted expenditures associated with installation of computer programs on computing systems that do not have all the dependent software modules that the computer programs require for loading and execution may be reduced.

A module, as disclosed herein, may be implemented in programmable hardware devices such as field programmable gate arrays, programmable array logic, programmable logic devices or the like. Modules may also include software-defined units or instructions, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored in different locations that, when joined logically together, comprise the module, and when executed by the processor, achieve the stated data transformation. A module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

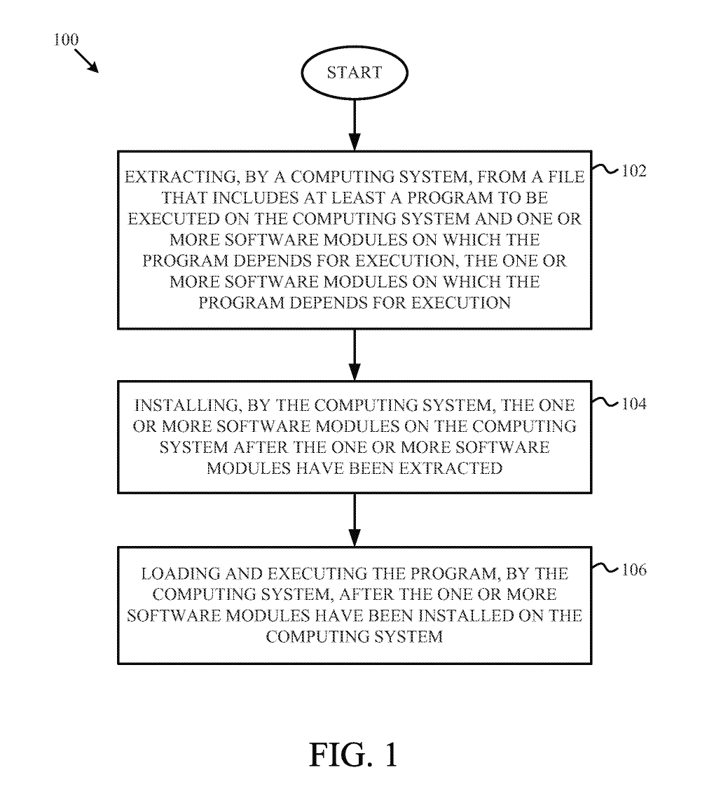

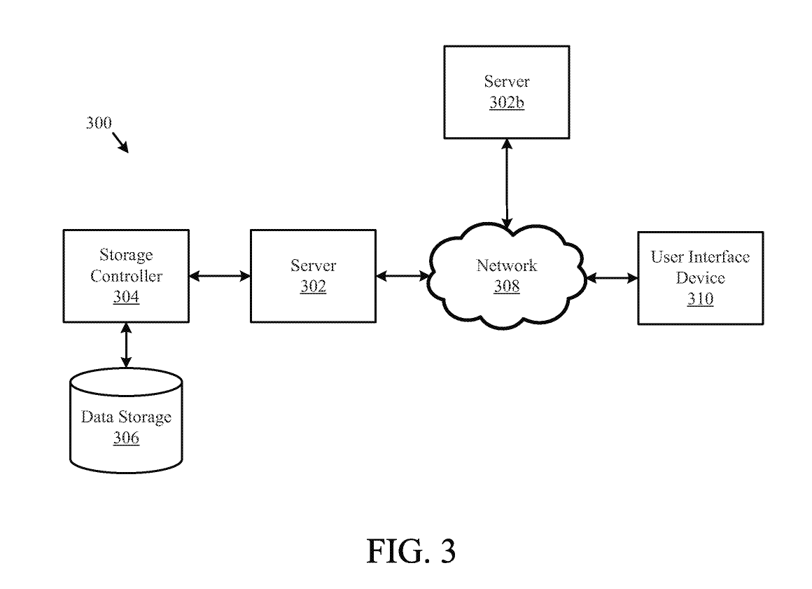

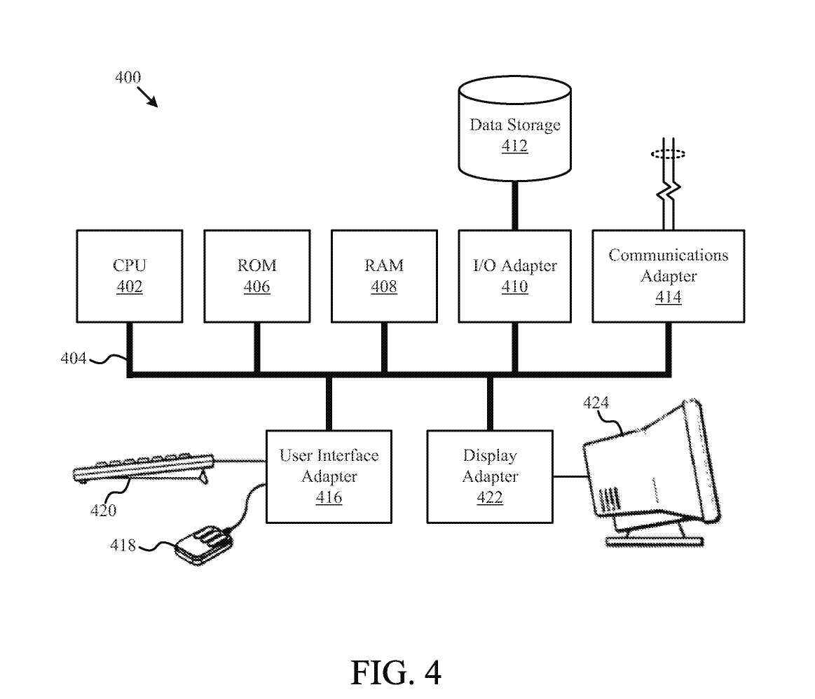

FIG. 1 is a flow chart illustrating a method for dynamically installing a program's dependent software modules before program execution according to one embodiment of the disclosure. It is noted that embodiments of method 100 may be implemented in accordance with the systems and embodiments described herein with respect to FIGS. 3-4. For example, embodiments of method 100 may be implemented by network 300 or computer system 400. In general, embodiments of method 100 may be implemented by other similar systems without deviating from this disclosure so long as the systems, whether directly or indirectly, support the operations as described herein.

Specifically, method 100 includes, at block 102, extracting, by a computing system, from a file that includes at least a program to be executed on the computing system and one or more software modules on which the program depends for execution, the one or more software modules on which the program depends for execution. In some embodiments, the file with the program and the one or more dependent software modules was previously built on another computing system. For example, in one embodiment, another computing system may have built the file to include at least the program to be executed on the computing system. To build the package that includes the computer program and the dependent software modules on which the computer program depends for execution, the other computing system may, during the building of the file, insert into the file the one or more software modules on which the computer program depends for execution. The file may subsequently be delivered to and received by the computing system on which the computer program is to be installed to begin the extraction step detailed at block 102.

In some embodiments, the file may be an Executable and Linkable Format (ELF) shared object, dynamically linked file, such as a .so file. In addition, in some embodiments, the computer program may be an extended network input output processor (XNIOP) computer program, and the one or more dependent software modules may include at least one of OpenSSL software and DNSSEC-Tools software, where DNSSEC is the acronym for Domain Name System (DNS) Security Extensions (DNSSEC)

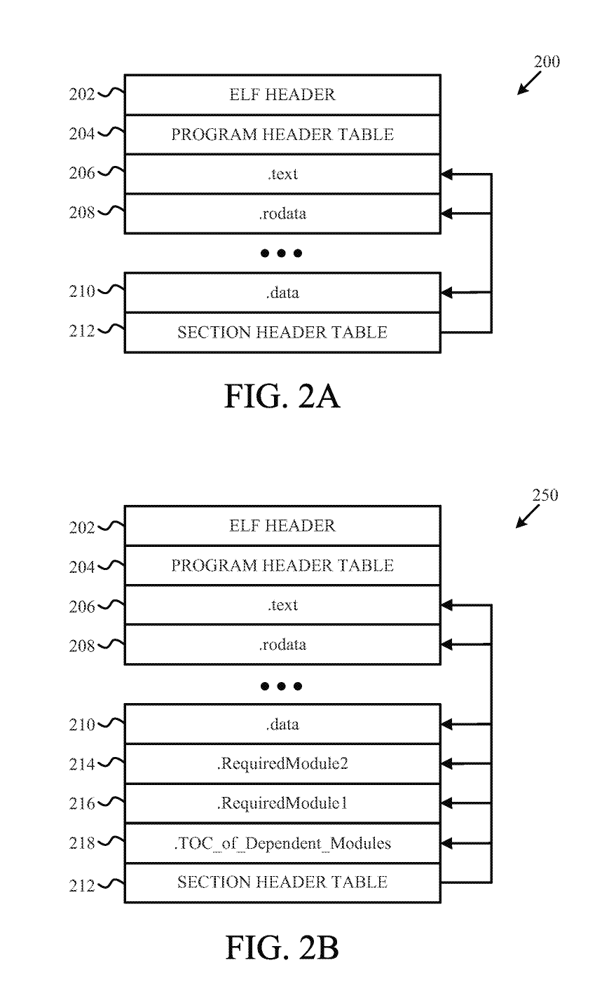

As an example, and not limitation, of the building of the packaged file, FIGS. 2A-2B provide diagrams illustrating the building of a packaged file that includes a computer program and the dependent software modules on which the computer program relies for loading and execution according to one embodiment of the disclosure. As shown in FIG. 2A, an ELF file 200 may include sections 206-210, which may be described by a section header table 212. In some embodiments, the section table header 212 may point to all of the sections in the ELF file 200. According to an embodiment, the sections 206-210 may be built into the ELF file 200 at compile time. However, in some embodiments, the sections 206-210 can also be “added in” programmatically. For example, a computing system may include a utility capable of programmatically inserting software modules into sections of an ELF file at build time. As an example. FIG. 2B illustrates an ELF file 250 in which dependent software modules 214 and 216 have been programmatically inserted into sections of the ELF file 200 to create ELF file 250. As shown in FIG. 2B, a library information section 218 may also be added to store a data table that includes information about the one or more dependent software modules that were built into the ELF file 250. In some embodiments, the information in the data table may include at least one of: a specification of how many software modules are built into the file, the names of the one or more software modules, and a specification of how many bytes are used for each of the one or more software modules.

In some embodiments, when a computing system on which the computer program is to be loaded and executed receives the packaged ELF file 250, the computing system may extract the data table from the file 250. According to an embodiment, the one or more dependent software modules may be extracted from the file, such as at block 102, based, at least in part, on the information in the extracted data table.

Returning to FIG. 1, at block 104, method 100 includes installing, by the computing system, the one or more software modules on the computing system after the one or more software modules have been extracted. In some embodiments, during the building of the file on a first computing system, a script may also be inserted into the packaged file, such as packaged ELF file 250 illustrated in FIG. 2. According to an embodiment, the script may be capable of installing, such as is described at block 104, the one or more software modules on a computing system on which the computer program is to be loaded. Therefore, in some embodiments, the computing system on which the computer program is to be loaded may, after receiving the packaged file, extract the script from the file and execute the script to install the one or more dependent software modules on the second computing system, such as at block 104.

At block 106, method 100 includes loading and executing the program, by the computing system, after the one or more software modules have been installed on the computing system. Accordingly, by performing the actions specified in embodiments of this disclosure, such as, for example, the actions specified at blocks 102-106, the computing system is able to load and execute a computer program regardless of the resources available on the computing system. For example, in some embodiments, the program may not be able to execute without the one or more dependent software modules installed on the computing system on which the computer program is being installed. Additionally, in some embodiments, the computing system may not include the one or more dependent software modules required by the computer program before attempting to execute the computer program, e.g., prior to extraction of the one or more dependent software modules from the file and installation of the one or more dependent software modules on the computing system. However, because the packaged file includes not only the computer program but also the software modules on which the computer program relies for execution, the computing system is able to load and execute a computer program regardless of the resources available on the computing system.

In some embodiments, the computing system on which the computer program is to be installed and executed may be the same computing system on which the packaged file was built. Therefore, in some instances, the computing system on which the computer program is to be installed and executed may have the dependent software modules required to load and execute the computer program. However, in some embodiments, even though the computing system on which the computer program is to be installed and executed is the same as the computing, system on which the packaged file was built, the computing system may no longer possess the dependent software modules required to execute the computer program when the computer program is to be executed. For example, the computing system may have been reconfigured or the dependent software modules accidently removed in the time between when the packaged file was built on the computing system and when the computer program is to be installed and executed on the computing system. However, as in the case when the computer program is to be installed and executed on a computing system different than the computing system on which the packaged file was built, because the packaged file includes not only the computer program but also the dependent software modules on which the computer program relies for execution, the computing system is able to load and execute a computer program despite having been reconfigured or having had necessary software modules removed.

In some embodiments, the solutions detailed herein may be advantageous over prior art solutions because they reduce the delay and/or wasted expenditures associated with installation of computer programs on computing systems that do not have all the dependent software modules that the computer programs require for loading and execution. Another advantage of the embodiments disclosed herein is that the packaged file may contain the full functionality of the dependent software modules required by a computer program for execution, in other words, the packaged file does not merely include “stub” software modules designed to look like the required software modules, but not including the functionality of the software modules. For example, in some embodiments, as described in U.S. patent application Ser. No. ______ “stub” software modules may be used to allow the computing system on which the computer program is to be installed and executed to resolve external references of the computer program, but the “stub” software modules may include no functionality of the dependent software modules, thus not permitting execution of the dependent software module's functionality. Therefore, to include the functionality of the dependent software modules, the software modules would still need to be separately retrieved and installed. In contrast, the packaged files disclosed herein may contain, in addition to the computer program, the dependent software module information needed to resolve external references of the computer program as well as the software functionality of the dependent software modules.

The schematic flow chart diagram of FIG. 1 is generally set forth as a logical flow chart diagram. As such, the depicted order and labeled steps are indicative of one embodiment of the disclosed method. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by various aspects of the systems disclosed herein. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

FIG. 3 illustrates one embodiment of a system 300 for dynamically installing a program's dependent software modules before program execution. The system 300 may include a server 302, a data storage device 306, a network 308, and a user interface device 310. The server 302 may also be a hypervisor-based system executing one or more guest partitions hosting operating systems with software modules having server configuration information. In a further embodiment, the system 300 may include a storage controller 304, or a storage server configured to manage data communications between the data storage device 306 and the server 302 or other components in communication with the network 308. In an alternative embodiment, the storage controller 304 may be coupled to the network 308.

In one embodiment, the user interface device 310 is referred to broadly and is intended to encompass a suitable processor-based device such as a desktop computer, a laptop computer, a personal digital assistant (PDA) or tablet computer, a smartphone or other mobile communication device having access to the network 308. In a further embodiment, the user interface device 310 may access the Internet or other wide area or local area network to access a web application or web service hosted by the server 302 and may provide a user interface for enabling a user to enter or receive information.

The network 308 may facilitate communications of data between the server 302 and the user interface device 310. In some embodiments, the network 302 may also facilitate communication of data between the server 302 and other servers/processors, such as server 302b. For example, the network 308 may include a switched fabric computer network communications link to facilitate communication between servers/processors, also referred to as data storage nodes. In some embodiments, the servers 302 and 302b may represent nodes or clusters of nodes managed by a software framework. The network 308 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

FIG. 4 illustrates a computer system 400 adapted according to certain embodiments of a server and/or a user interface device. The central processing unit (“CPU”) 402 is coupled to the system bus 404. The CPU 402 may be a general purpose CPU or microprocessor, graphics processing unit (“GPU”), and/or microcontroller. The present embodiments are not restricted by the architecture of the CPU 402 so long as the CPU 402, whether directly or indirectly, supports the operations as described herein. The CPU 402 may execute the various logical instructions according to the present embodiments.

The computer system 400 may also include random access memory (RAM) 408, which may be synchronous RAM (SRAM), dynamic RAM (DRAM), synchronous dynamic RAM (SDRAM), or the like. The computer system 400 may utilize RAM 408 to store the various data structures used by a software application. The computer system 400 may also include read only memory (ROM) 406 which may be PROM, EPROM, EEPROM, optical storage, or the like. The ROM may store configuration information for booting the computer system 400. The RAM 408 and the ROM 406 hold user and system data., and both the RAM 408 and the ROM 406 may be randomly accessed.

The computer system 400 may also include an input/output (I/O) adapter 410, a communications adapter 414, a user interface adapter 416, and a display adapter 422. The I/O adapter 410 and/or the user interface adapter 416 may, in certain embodiments, enable a user to interact with the computer system 400. In a further embodiment, the display adapter 422 may display a graphical user interface (GUI) associated with a software or web-based application on a display device 424, such as a monitor or touch screen.

The I/O adapter 410 may couple one or more storage devices 412, such as one or more of a hard drive, a solid state storage device, a flash drive, a compact disc (CD) drive, a floppy disk drive, and a tape drive, to the computer system 400. According to one embodiment, the data storage 412 may be a separate server coupled to the computer system 400 through a network connection to the I/O adapter 410. The communications adapter 414 may be adapted to couple the computer system 400 to a network, which may be one or more of a LAN, WAN, and/or the Internet. The user interface adapter 416 couples user input devices, such as a keyboard 420, a pointing device 418, and/or a touch screen (not shown) to the computer system 400. The display adapter 422 may be driven by the CPU 402 to control the display on the display device 424. Any of the devices 402-422 may be physical and/or logical.

The applications of the present disclosure are not limited to the architecture of computer system 400. Rather the computer system 400 is provided as an example of one type of computing device that may be adapted to perform the functions of a server and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, in some embodiments, aspects of the computer system 400 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data may be configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for dynamically installing a program's dependent software modules before program execution, comprising:
extracting, by a computing system, from a file that includes at least a program to be executed on the computing system and one or more software modules on which the program depends for execution, the one or more software modules on which the program depends for execution;
installing, by the computing system, the one or more software modules on the computing system after the one or more software modules have been extracted; and
loading and executing the program, by the computing system, after the one or more software modules have been installed on the computing system.

2. The method of claim 1, wherein the file with the program and the one or more software modules was previously built on another computing system.

3. The method of claim it wherein the program cannot execute without the one or more software modules.

4. The method of claim 1, wherein the computing system does not include the one or more software modules prior to extraction of the one or more software modules from the file and installation of the one or more software modules on the computing system.

5. The method of claim 1, wherein the file is an Executable and Linkable Format (ELF) shared object, dynamically linked file.

6. The method of claim 1, wherein the one or more software modules include at least one of an OpenSSL software module and a DNSSEC-Tools software module.

7. The method of claim 1, further comprising:
extracting, by the computing system, a data table from the file, wherein the one or more software modules are extracted from the file based, at least in part, on the information in the extracted data table,
wherein the data table includes information about the one or more software modules that were built into the file, and wherein the information includes at least one of: a specification of how many software modules are built into the file, the names of the one or more software modules, and a specification of how many bytes are used for each of the one or more software modules.

8. The method of claim 1, further comprising extracting, by the computing system, a script from the file, wherein the script is executed to install the one or more software modules on the computing system.

9. A computer program product, comprising:
a non-transitory computer readable medium comprising instructions which, when executed by a processor of a computer system, cause the processor to perform the steps of:
extracting, from a file that includes at least a program to be executed on the computing system and one or more software modules on which the program depends for execution, the one or more software modules on which the program depends for execution;
installing the one or more software modules on the computing system after the one or more software modules have been extracted; and
loading and executing the program after the one or more software modules have been installed on the computing system.

10. The computer program product of claim 9, wherein the file with the program and the one or more software modules was previously built on another computing system.

11. The computer program product of claim 9, wherein the program cannot execute without the one or more software modules, and wherein the computing system does not include the one or more software modules prior to extraction of the one or more software modules from the file and installation of the one or more software modules on the computing system.

12. The computer program product of claim 9, wherein the file is an Executable and Linkable Format (ELF) shared object, dynamically linked file, and wherein the one or more software modules include at least one of an OpenSSL software module and DNSSEC-Tools software module.

13. The computer program product of claim 9, wherein the medium further comprises instructions which cause the processor to perform the step of:
extracting a data table from the file, wherein the one or more software modules are extracted from the file based, at least in part, on the information in the extracted data table,
wherein the data table includes information about the one or more software modules that were built into the file, and wherein the information includes at least one of: a specification of how many software modules are built into the file, the names of the one or more software modules, and a specification of how many bytes are used for each of the one or more software modules.

14. The computer program product of claim 9, wherein the medium further comprises instructions which cause the processor to perform the step of extracting a script from the file, wherein the script is executed to install the one or more software modules on the computing system.

15. An apparatus, comprising:
a memory; and
a processor coupled to the memory, wherein the processor is further configured to perform the steps of:
extracting, from a file that includes at least a program to be executed on the computing system and one or more software modules on which the program depends for execution, the one or more software modules on which the program depends for execution;
installing the one or more software modules on the computing system after the one or more software modules have been extracted; and
loading and executing the program after the one or more software modules have been installed on the computing system.

16. The apparatus of claim 15, wherein the file with the program and the one or more software modules was previously built on another computing system.

17. The apparatus of claim 15, wherein the program cannot execute without the one or more software modules, and wherein the computing system does not include the one or more software modules prior to extraction of the one or more software modules from the file and installation of the one or more software modules on the computing system.

18. The apparatus of claim 15, wherein the file is an Executable and Linkable Format (ELF) shared object, dynamically linked file, and wherein the one or more software modules include at least one of an OpenSSL software module and a DNSSEC-Tools software module.

19. The apparatus of claim 15, wherein the processor is further configured to perform the step of:
extracting a data table from the file, wherein the one or more software modules are extracted from the file based, at least in part, on the information in the extracted data table,
wherein the data table includes information about the one or more software modules that were built into the file, and wherein the information includes at least one of: a specification of how many software modules are built into the file, the names of the one or more software modules, and a specification of how many bytes are used for each of the one or more software modules.

20. The apparatus of claim 15, wherein the processor is further configured to perform the step of extracting a script from the file, wherein the script is executed to install the one or more software modules on the computing system.
